(19) United States
(12) Patent Application Publication
(10) Pub. No.: US 2019/0129517 A1
(43) Pub. Date: May 2, 2019

(54) REMOTE CONTROL BY WAY OF SEQUENCES OF KEYBOARD CODES

(71) Applicant: Light Wave Technology Inc., St. Laurent (CA)

(72) Inventors: Jack WISNIA, Dollard-Des Ormeaux (CA); Feng DU, Kirkland (CA)

(73) Assignee: Light Wave Technology Inc., St. Laurent, QC (CA)

(21) Appl. No.: 16/096,527

(22) PCT Filed: Jun. 16, 2017
(86) PCT No.: PCT/CA2017/050740

§ 371 Date: Oct. 25, 2018

(30) Foreign Application Priority Data
Jun. 17, 2016 (CA) PCT/CA2016/050710
Jul. 11, 2016 (CA) PCT/CA2016/050809
Mar. 2, 2017 (CA) PCT/CA2017/050285

(51) Int. Cl. G06F 3/023; G06F 3/0488; G06F 3/0489; G06F 21/30

(52) U.S. Cl. CPC G06F 3/0231; G06F 21/30; G06F 3/0489; G06F 3/04886

(57) ABSTRACT

An activation device controls a computing device. It has a user input interface, a keyboard interface for connecting to the computing device, a memory for storing at least one sequence of keyboard commands, and a controller configured to store in memory the sequence of keyboard commands and to be responsive to the user input interface for transmitting the sequence of keyboard commands stored in memory to the computing device.

This application is a CIP of PCT/CA2017/050285 filed on Mar. 2, 2017, now pending, that claims priority of U.S. provisional No. 62/323,031 filed Apr. 15, 2016, now abandoned, and is a CIP of PCT/CA2016/050809 filed on Jul. 11, 2016, now pending, that is a CIP of PCT/CA2016/050710 filed Jun. 17, 2016, now abandoned.

### TECHNICAL FIELD

The present application relates to computing device interfaces for activating and controlling computing devices, namely smartphones running with an operating system that restricts application programs from unlocking said computing device, prevents causing application programs from switching between foreground and background modes, allows for multiple application programs to run at the same time in a sandboxed manner such that they are limited in their communication and sharing of data between application programs and/or that otherwise regiment interaction between application programs.

### BACKGROUND

Most smartphones have multiple applications or apps, and the user typically uses a touch screen interface, with or without key presses, to unlock the phone and to run the application. This requires typically a number of strokes, attention and dexterity.

Moreover, certain operating systems permit only authorized application programs to unlock said computing device and regiments interaction between application programs. Such operating systems include the Apple™'s iOS, run on such devices as the Apple iPad or iPhone®. Users of iPad and iPhone computing devices cannot effectively be controlled remotely using a device that is known in the art for running certain desired applications programs or carrying our certain actions. As a result, users of iPads and iPhones are required to perform the sequence of keystrokes, such as those of unlocking the computing device and navigating through the system if they desire to access a specific application program. This manual navigation may be undesirable and cumbersome in situations where the user is occupied or has limited use of his or her hands, such as when driving, bicycling, or when the user suffers from a disability resulting in reduced usage of his or her hands.

### SUMMARY

Applicant has discovered that keyboard commands, such as consumer control button (CCB) commands, can be used by a peripheral device to control a computer to rapidly control a state of the computer, for example to bring an application associated with a peripheral device on the computer to be seen and to be run in the foreground for the user, or to change the settings in the operating system of the computer.

The peripheral device that controls the computer in this way can be a dedicated device whose purpose is to send the commands that control the computer, or it can be a device that has a different primary function that cooperates with the computer. In the latter case, the sending of keyboard commands to the computer can help the computer cooperate with the peripheral device to perform the intended function.

In the case of a peripheral device wirelessly connected to the computer via Bluetooth, the same Bluetooth connection can be used for data communication and for a keyboard. However, the keyboard commands can be communicated over a separate link from other data between the peripheral device and the computer, when applicable. This allows the computer to be used for other applications while also allowing the peripheral device's application to be run in the foreground at the control of peripheral device.

More specifically, Applicant has also discovered that a smartphone can be controlled to unlock and open a desired app using Bluetooth keyboard device commands so as to avoid requiring a user to perform equivalent actions to be ready to use the smartphone in a particular app.

A first broad aspect is an activation device for controlling a computing device having an external keyboard interface for connecting and receiving keyboard input from an external keyboard and an operating system. The activation device has a user input interface, a keyboard interface for connecting to the external keyboard interface of the computing device. The activation device has a memory for storing at least one sequence of keyboard commands that is configured to be received by a operating system of the computing device and processed by the operating system of the computing device to cause the operating system to carry out designated functions on the computing device, the at least one sequence of keyboard commands comprising at least one of a first sequence of keyboard commands for causing the unlocking of the computing device; and/or a second sequence of keyboard commands for causing the user interface of the operating system to navigate through application programs, to select a designated application program amongst the application programs and to launch the designated application program. The activation device also has a controller configured to be responsive to the user input interface for transmitting one of the at least one sequence of keyboard commands stored in the memory to the external keyboard interface of the computing device.

In some embodiments, the operating system may limit the capacity of an application program from calling to the foreground another application program.

In some embodiments, the keyboard interface may be a wireless interface, preferably Bluetooth. In other embodiments, the keyboard interface may be a wired interface. The at least one sequence of keyboard commands may also include commands for causing the operating system of the computing device to bring an application program running in the foreground to the background. In some embodiments, the at least one sequence of keyboard commands may also have commands to cause an application program to run in the foreground.

In some embodiments, the user input interface may have a plurality of user keys, each associated with a predetermined sequence of keyboard commands. One of the plurality of user keys may be associated with a predetermined sequence of keyboard commands to cause the computing device to select a predetermined touch-screen keyboard. The activation device may be adapted to receive and respond to data from the computing device.

In some embodiments, the keyboard interface may be further configured to receive keyboard command data from the computing device, and the memory may be further configured to store the received keyboard command data. In some embodiments, the activation unit may have a voice command processor. The user input interface may be further configured to receive audio input from a user, and the voice command processor may be configured to process the audio input.

The user input interface may have an interface connectable to a keyboard device and may be configured to cause the keyboard interface to issue keystroke commands in response to keyboard device signals. The controller may be further configured to receive keyboard command configuration data from the computing device. The keyboard command configuration data may correspond to a sequence of keyboard commands for storage in the computer readable memory.

The activation device may also have a peripheral data interface configured to communicate with a peripheral, wherein the at least one sequence of keyboard commands may include a third sequence of keyboard commands to launch an application program on the computing device associated with the operation of the peripheral, and wherein specific user input indicative of a user wanting to use the peripheral received by the user input interface may cause the controller to send the third sequence of keyboard commands to the computing device. The activation unit may also have a battery for powering the activation device.

A second broad aspect is an activation device for controlling a computing device having an external keyboard interface for connecting and receiving keyboard input from an external keyboard and an operating system of the computing device. The activation unit has a data transceiver having a configuration defining transmission of messages over an established connection and responses to received messages, the received messages comprising a trigger response message. The activation unit also has computer readable memory configured to store at least one sequence of keyboard commands. The at least one sequence of keyboard commands includes a first sequence of keyboard commands to cause an operating system of the computing device to carry out a specific function. The activation device also has a controller configured to be responsive to the trigger response message received by the data transceiver to transmit the first sequence of keyboard commands stored in the memory to the external keyboard interface of the computing device. The data transceiver is configured to establish a data connection with the computing device, and once the data connection is established between the data transceiver and the computing device, periodically send over the data connection messages to the smartphone to cause an activation of a user input detection application program to run on the computing device and to detect user input, in response to which the user input detection application program is configured to send the trigger response message.

In some embodiments, the data transceiver may be a wireless transceiver, and the data connection may be a wireless connection. The wireless transceiver may be a Bluetooth wireless transceiver, and the wireless connection may be a Bluetooth connection. The data connection may be a wired connection. The data connection messages may be pings.

The sequence of keyboard commands may be to cause the computing device to unlock and/or to cause the operating system of the computing device to run a predetermined application program.

In some embodiments, the activation unit may also have a user input interface configured to receive additional user input, wherein the at least one sequence of keyboard commands may include an additional input sequence of keyboard commands associated with the additional user input, and wherein the controller may be further configured to be responsive to the additional user input to transmit at least one of the at least one sequence of keyboard commands. The activation device may also have a battery for powering the activation device.

The user input interface may be at least one button. The user input interface may be a motion sensor. The user input interface may be responsive to speech from a user and may have at least one microphone, and a voice command processor configured to recognize the speech command expressed in the speech of the user received from the at least one microphone, and wherein the additional user input is the speech.

The user input interface may have a plurality of user keys, each associated with a predetermined sequence of keyboard commands. One of the plurality of user keys may be associated with a predetermined sequence of keyboard commands to cause the computing device to select a predetermined touch-screen keyboard.

A third broad aspect is a voice-controlled device for use with a computing device having a display and an external keyboard input for receiving user keyboard input. The voice-controlled device has at least one processor, a keyboard output interface for connecting to the external input keyboard interface of the computing device, at least one microphone and at least one speaker. The voice-controlled device also has at least one computer-readable media storing computer-executable instructions that, when executed by the at least one processor, causes the at least one processor to perform acts that include recognizing a speech command from a user received from the at least one microphone; interpreting the speech command to determine a suitable interactive response to the speech command comprising an audio message to be output through the at least one speaker for providing an interactive response to the user, and a keyboard data command for the computing device to be output using the keyboard output interface for causing the computing device to display visual information for the user.

In some embodiments, the suitable interactive response to the speech command may also include a command for an application in the computer-readable media for performing a task requested by the user involving audio output using the at least one speaker.

In some embodiments, the speech-controlled device may have a speech generator configured to generate the audio message. The keyboard command data may be processed by the operating system of the computing device, received by the keyboard input interface of the computing device, as keyboard commands transmitted by an external peripheral device that cause the user interface of the operating system to carry out a specific function.

The connection between the keyboard output interface of the voice-controlled device and the keyboard input interface of the computing device may be wireless. The wireless connection between the keyboard output interface of the voice-controlled device and the keyboard input interface of the computing device may be a Bluetooth connection. The voice-controlled device may be configured to detect if the computing device is in proximity to the voice-controlled device and may establish a wireless connection with the computing device when the computing device is in proximity with the voice-controlled device.

The connection between the keyboard output interface of the voice-controlled device and the keyboard input interface of the computing device may be wired. The act of recognizing a speech command may also include comparing the speech of the user with user profile information contained in a user profile database to establish if the speech is that of the user.

In some embodiments, the acts may also include, prior to the recognizing of a speech command, detecting a key speech trigger expressed by the user indicative of the user formulating a speech command. The suitable interactive response to the speech command may also include sending a keyboard data command for the computing device to be output using the keyboard output interface for causing the computing device to unlock. The suitable interactive response to the speech command may also include sending a keyboard data command for the computing device to be output using the keyboard output interface for causing the operating system to process the keyboard command date and the user interface of the operating system of the computing device to launch a designated application program on the computing device.

### BRIEF DESCRIPTION OF THE DRAWINGS

The invention will be better understood by way of the following detailed description of embodiments of the invention with reference to the appended drawings, in which:

FIG. 1A is a block diagram illustrating a smartphone app activator unit to cause a string of Bluetooth keyboard commands to be issued to the smartphone to unlock the phone and call up a corresponding app;

FIG. 1B is a block diagram illustrating a smartphone app activator unit having four buttons to cause a string of Bluetooth keyboard commands to be issued to the smartphone to unlock the phone and call up an app corresponding respectively to each of the four buttons;

FIG. 2 is a flow chart diagram showing the steps involved in controlling a computing device using a stored sequence of keyboard commands according to one embodiment;

FIG. 3 is a flow chart diagram showing the steps involved in controlling a computing device using a stored sequence of keyboard commands according to another embodiment in which a special keyboard app is used to gather user character input while giving the appearance of remaining in another app receiving that character input;

FIG. 4A is a block diagram illustrating an exemplary activation unit acting as a speech-controlled device for processing voice commands that can cause a string of Bluetooth keyboard commands to be issued to the smartphone for carrying out a specific action;

FIG. 4B is a block diagram illustrating another exemplary activation unit acting as a speech-controlled device for processing voice commands that can cause a string of Bluetooth keyboard commands to be issued to the smartphone for carrying out a specific action;

FIG. 5 is an oblique view of a wireless, battery-powered activator unit that can activate a smartphone through Bluetooth keyboard commands;

FIG. 6 is a blog diagram of an exemplary activation unit configured to send pings to bring to the foreground a user input detection background application program that is responsive to specific user input, the user input acting as a signal for activating a predetermined application program with keyboard commands.

FIG. 7 is a flowchart diagram of an exemplary method of launching a predetermined application program by using an activation unit, and a background application program running on the computing device that is configured to detect specific user input.

FIG. 8 is a block diagram of an exemplary activation unit in communication with a peripheral device, where the computing device has an application program related to the peripheral device.

### DETAILED DESCRIPTION

An activator unit, responding to user input such as the press of a button, may be used to control a smartphone to carry out certain actions on the smartphone without requiring further user input. The smartphone runs a restrictive operating system that, for example, does not permit application programs to unlock said computing device and regiments interaction between application programs, and has an external keyboard interface to connect with an external keyboard or peripheral (may be wired, or wireless). Such actions that are carried out by using the activator unit may include, but are not limited to, unlocking the smartphone, launching an application program, automatically dialing a phone number of a contact or looking for contact information. The activator unit sends a sequence of keyboard commands wirelessly to an external keyboard interface of the smartphone. The smartphone receives these keyboard commands, processes them, and carries out the desired action associated with the keyboard commands.

While in this description reference is made to Bluetooth wireless transmission, it is to be understood that this is a commonly used wireless transmission protocol. It will be appreciated that any suitable wireless transmission protocol can be applied to variant embodiments herein.

While in this description reference is made to iPhone, a smartphone designed by Apple Inc. of California, it is intended that the device can be any electronic device, such as a laptop or desktop computer, a smart phone or a tablet computer, such as an iPhone, iPod touch, Android tablet or Android smart phone, GPS unit, display and the like.

In the present application, reference is made to keyboard commands. A keyboard command is a series of one or more HID commands. A keyboard command may be one or more keys that can cause an event, e.g. invoking a software operation or an operating system operation, etc.

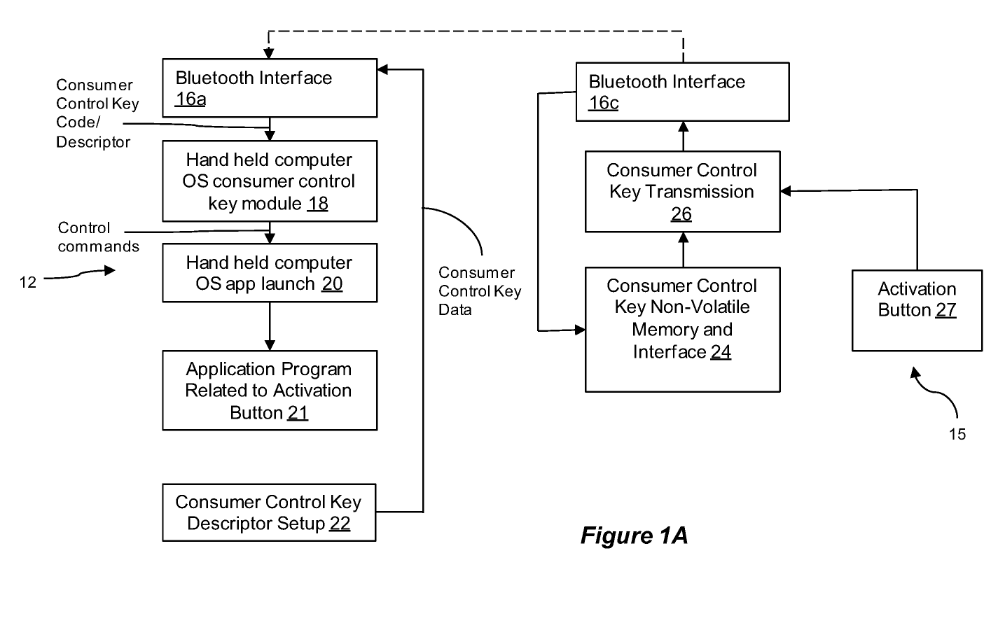

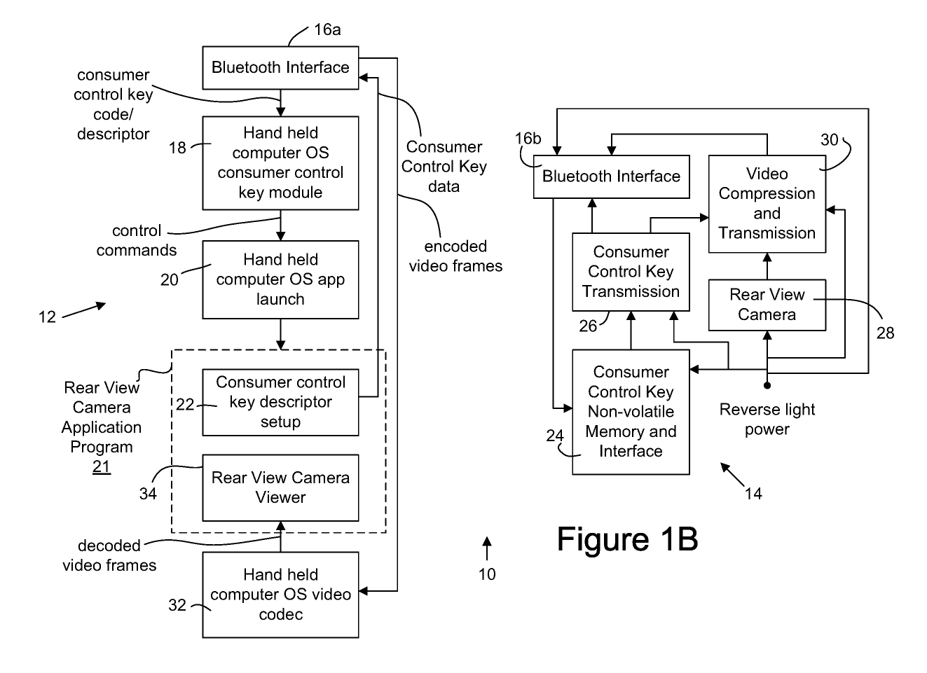

Reference is now made to FIG. 1A illustrating an exemplary activation unit 15 in wireless communication with the smartphone 12. It will be appreciated that the communication between the activation unit 15 and the smartphone 12 may be wired, such as when the activation unit 15 is connected to the smartphone 12 via a connection port (e.g. lightning port).

The activation unit 15 has a Bluetooth interface 16c, a consumer control key transmission module 26, a consumer control key non-volatile memory interface 24 and at least one activation button 15. The activation unit 15 may also have a battery.

The Bluetooth interface 16c is a wireless interface for receiving (e.g. keyboard command configuration data for configuring the sequence of keyboard commands for each of the activation buttons 27) and sending data, including keyboard commands to a smartphone. It will be appreciated that interface 16c may be another wireless interface than one running on Bluetooth. Moreover, in some embodiments, the interface 16c may be one for establishing a wired connection between the activation unit 15 and the smartphone 12 (e.g. using a connection port, such as the lighting port for an iOS device).

The consumer control key transmission module 26 is a program that is stored in memory and executable by a processor (e.g. a general purpose programmable processor, a microprocessor). The consumer control key transmission module 26 may retrieve from memory 24 the keyboard commands as well as instructions stored in memory to transmit the keyboard commands associated with a given activation button 27. The processor is connected to the activation button 27 via, for instance, a BUS, to receive a signal that a button 27 has been pressed. The processor, carrying out the instructions of the consumer control key transmission module 26, retrieves from memory the keyboard commands associated with the pressed button 27. The processor is connected via, for instance, a BUS, with the Bluetooth interface 16c. Consumer control key transmission module 26 further sends the retrieved keyboard commands to the Bluetooth interface 16c. In some embodiments, the processor may include non-volatile memory, while in others, the memory may be separate from the processor.

Consumer control key non-volatile memory and interface 24 is computer readable memory that may store the keyboard commands for at least one activation button, and instructions that are readable and may be executed by the consumer control key transmission module 26. Memory 24 may be the same or different memory than that for storing the consumer control key transmission module 26. The consumer control key non-volatile memory and interface 24 may also have an interface for receiving the keyboard command configuration data from the Bluetooth interface 16c, further stored in the memory 24.

The activation button 27 may be a device for receiving user input. The activation button 27 may be, for instance, a push-button, a button reacting to a touch, an optical sensor for detecting a hand movement, a heat sensor or humidity sensor. The activation button 27 may be any device for picking up user input or for reacting when ambient conditions undergo a change (e.g. humidity increase in a room, temperature drop or increase in a room).

Schematically illustrated in FIG. 1A are modules 18 and 20 that represent parts of the smartphone 12 operating system that process wireless keyboard commands and allow such commands to launch application programs or apps. In the case of the Apple iPhone®, keyboard commands can be used to perform actions that normally are associated with the device's touch screen actions or buttons, as for example, the swipe action to initiate unlocking a locked phone, the pressing of the home button, volume control, etc. Likewise, running a desired app can be implemented by using a keyboard command to initiate a search or find on the smartphone, and then sending keystrokes of the name of the app on the smartphone 12 will cause the desired app 21 to be found, with another keystroke, such as ENTER.

When the activation device 15 transmits the keyboard commands to the smartphone 12, an HID keyboard is started using a classic Bluetooth connection. Module 26 then sends a sequence of keyboard commands stored in memory 24. In the case of an iPhone, this can comprise the following steps:
send HID keyboard command for unlock swipe
send passcode 4 digits or long passcode with ENTER
the Bluetooth keyboard can be stopped so as to be able to use an assistive touch command
send iOS launch command to launch app 21
Optionally, the user may be required to press an “allow” button on the touchscreen of the smartphone to enable “AssistiveTouch” to run.
Optionally, start iOS AssistiveTouch
Start HID point device (Mouse service)
Move mouse pointer to the “OK” confirm position and press to actually start the desired APP associated with the activation device

An example of a command that simulates a press on touch screen can be as follows:

```
Enable assistive touch
/* HID map descriptor */
const unsigned char startHidMouseMessage[ ] =
{
  /* param 1 HIDComponentIdentifier*/
  0x00,0x06, /* length */
  0x00,0x00, /* ID */
  0x00,0x00,
  /* param 2 vendorIdentifer */
  0x00,0x06, /* length */
  0x00,0x01, /* ID */
  0x04,0x61,
  /* param 3 productIdentifier */
  0x00,0x06, /* length */
  0x00,0x02, /* ID */
  0x00,0x00,
  /* param 4 HID report descriptor */
  0x00,0x36, /* length */
  0x00,0x04, /* ID */
  0x05 ,0x01,
  0x09 ,0x02,
  0xa1 ,0x01,
  0x09 ,0x01,
  0xa1 ,0x00,
  0x05 ,0x09,
  0x19 ,0x01,
  0x29 ,0x03,
  0x15 ,0x00,
  0x25 ,0x01,
  0x95 ,0x03,
  0x75 ,0x01,
  0x81 ,0x02,
  0x95 ,0x01,
  0x75 ,0x05,
  0x81 ,0x01,
  0x05 ,0x01,
  0x09 ,0x30,
  0x09 ,0x31,
  0x15 ,0x81,
  0x25 ,0x7f,
  0x75 ,0x08,
  0x95 ,0x02,
  0x81 ,0x06,
  0xc0 ,
  0xc0
};
  ISPP_Send_Control_Message(BluetoothStackID,
SerialPortID,0x5400,0,NULL); //start assistivetouch
  ISPP_Send_Control_Message(BluetoothStackID,
SerialPortID,0x6800,sizeof(startHidMouseMessage),(unsigned
char *)startHidMouseMessage);
To simulate the screen press:
unsigned char mouseCmd[ ] =
{
  /* param 1 HIDComponentIdentifier*/
  0x00,0x06, /* length */
  0x00,0x00, /* ID */
  0x00,0x00,
  /* param 2 vendorIdentifer */
  0x00,0x07, /* length */
  0x00,0x01, /* ID */
  0x01,0x00,0x00
};
ISPP_Send_Control_Message(BluetoothStackID,
SerialPortID,0x6802,sizeof(mouseCmd),mouseCmd);
```

The memory 24 may store one sequence of keyboard commands associated with one task, or multiple sequences of keyboard commands, each associated to at least one task, such as, unlocking the smartphone 12, searching for the application program 21, running the application program 21.

The sequence of keyboard commands, once transmitted to the wireless interface 16a, are received by the operating system of the computing device 12. The operating system processes the sequence of keyboard commands, and the user interface of the operating system is caused to carry out a designated function associated with the sequence of keyboard commands. For instance, the designated function may be to cause a user interface of the operating system to navigate through application programs of the computing device 12, select a designated application program 21 associated with the sequence of keyboard commands, and launch the designated application program 21. In some examples, such as in some embodiments with a computing device 12 operating with an iOS, the navigation of application programs may be performed by using “Global Search” and by sending the keyboard commands corresponding to the sequence of keys necessary to type the name of the designated application program that is the subject of the search, and then selecting the designated application program. In other embodiments, the sequence of keyboard commands may be to unlock the smartphone, such as by sending a sequence of keyboard commands to cause the user interface of the operating system to carry out the unlocking of the phone. The sequence of keyboard commands may perform tasks traditionally associated with user input received directly on the user interface of the smartphone 12, such as navigate through application programs, selecting an application program or carrying out the steps necessary to unlock the smartphone 12. The sequence of keyboard commands is a series of keyboard commands, where the combined sequence, once executed by the operating system, yields a result that is traditionally achieved after receiving a sequence of input from a user (e.g. multiple finger gestures and touches). These actions may be now carried out without this user input on the user interface, as the sequence of keyboard commands may effectively control the smartphone 12 to mimic the user input (e.g. gestures, swipes and finger press).

For instance, in some examples of the iPhone® and/or an iOS, the sequence of keyboard commands may be those associated with keyboard keys or keyboard shortcuts, like an iPad keyboard shortcut, such as “command+space” to perform a system wide search, “command+shift+H” to navigate to the home screen, “command+shift+tab” to switch to previous application program, “command+tab” to switch to the original application program, “up arrow+down arrow” to simultaneously tap selected item, “shift+tab” to return to the previous field, etc.

In other examples, the keyboard commands may not need to include those for unlocking the smartphone 12. For instance, the sequence of keyboard commands may be limited to those necessary to run the application program 21. Once the smartphone 12 receives the sequence of keyboard commands, the sequence may be processed by the OS of the smartphone 12 to cause the application program 21 to run and to present a notification window appearing on the screen of the smartphone 12 when the smartphone 12 is locked. For example, in the case of an iOS device, such as the iPhone 6, the user may swipe to the side the notification box corresponding to app 21 and, by using the iOS device's fingerprint security protocol, unlock the device by presenting the user's fingerprint (or the user may type in the user's unlock code). Once the smartphone 12 unlocked, app 21 begins to run and the app 21 may move to the foreground of the smartphone 12 (and move another application program currently running in the foreground into the background).

It will be understood that the sequence of keyboard commands used to cause the smartphone to perform certain tasks, such as its unlocking or running a designated application, depends on the platform of the smartphone. The sequence of keyboard commands also depends upon the task to be carried out. Therefore, a skilled person will readily understand that a desired sequence of keyboard commands for a specific platform may be determined using basic trial and observation, where the effect of receiving a specific sequence of keyboard commands by the smartphone is monitored for the desired action.

In some embodiments, the sequence of keyboard commands to launch the predetermined application program 21 may be preceded by the sending of at least one character to the smartphone 12 for lighting up the smartphone 12, followed by the sequence of keyboard commands for unlocking the smartphone 12 and running the viewing application program 21. In other embodiments, the sequence of keyboard commands may be limited to those for running the application program 21.

Activator unit 15 can be a small battery-powered button supported on a key-chain, dashboard of a vehicle, visor, air vent, or any other suitable location that can allow the user to press a button (or otherwise issue a command) to cause the unit 15 to send a wireless signal to the smartphone 12 to perform the desired function on the smartphone 12. Unit 15 can be a stand-alone device or it can be integrated into a phone holder/case or tablet holder/case.

As shown in FIG. 1A, the activator unit 15 can be used to activate the smartphone 12 directly using wireless keyboard commands to unlock, if required, and to launch a desired app 21. The keyboard command transmission modules 24 and 26 are provided in unit 15 in the embodiment of FIG. 1A. The Bluetooth interface 16c of unit 15 transmits keyboard commands directly to the wireless interface 16a of the smartphone 12. The wireless interface 16a may be an external keyboard interface, such as an interface for wirelessly connecting to an external peripheral device, such as a keyboard, mouse or joystick. In the embodiment of FIG. 1A, there is one app launch button. However, as shown in FIG. 1B, the activation unit 15 may have more than one app launch button, e.g. 4 buttons 27, each of the app launch buttons 27 associated with different apps. In the example of FIG. 1B, each of the four app launch buttons 27 is associated with different apps 21a through 21d (FIG. 1B shows only apps 21a and 21d for clarity of illustration). Each of the launch buttons 27 may be associated with different functions on the smartphone 12 (e.g. looking for a specific contact, unlocking the phone, launching an app, etc.).

Moreover, using a separate app 22, the smartphone is used to configure what keyboard commands are required to launch the individual apps using buttons 27. This keyboard command data is then sent, via, for instance, the wireless communication channel established between the Bluetooth interface 16a and the Bluetooth interface 16c (or by a different wireless channel, or data channel, between the activation unit 15 and the smartphone 12), to the unit 15 for storage in memory 24. The command data is received by Bluetooth interface 16c (or another data interface of the activation unit 15), the command data having metadata indicating which button the button with which the command data may be associated with. The command data and its metadata are stored in memory 24. It will be appreciated that loading of the commands into memory 24 can be done using a different device than the smartphone 12 using any suitable interface.

The selector buttons 27 can be of any desired number. While each control can be associated with a different app, it will be appreciated that a control can be associated with a particular function among many functions available within an app or within the operating system controls. For example, a single button 27 can be used to configure the smartphone 12 for use in a given context, such as when driving a car or being used by a customer. For example, the settings can be caused to prevent sleep mode or screen turn-off, setting WiFi to a desired connection or off state and then selecting the desired app to be on the surface for the context. In the case of the Apple iOS, the device can be caused to be in “guided access” mode in which the smartphone is locked into one single app that is commonly used with customers or guest users. The same button with a second press or a different type of press (or a separate reset button) can cause the module 26 to issue keyboard commands to restore smartphone operation to the original state. For example, the system setting that allows the screen to turn off after a period of non-use can be restored, and in the case of guided access mode, that mode can be turned off. As desired, the smartphone 12 can be left on or locked with the commands sent by such restore commands.

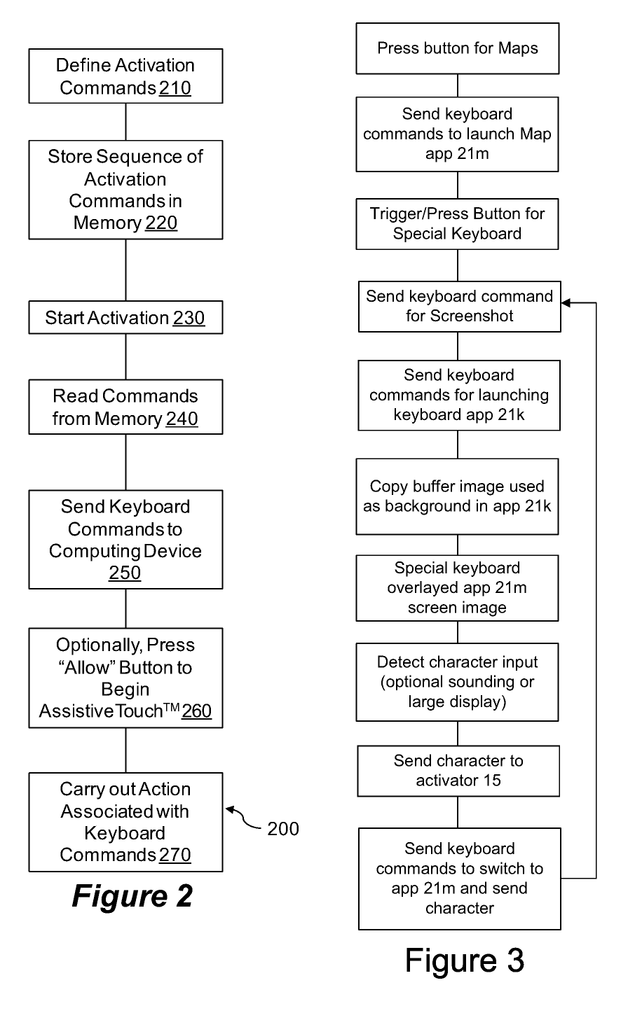

Reference is now made to FIG. 2, illustrating an exemplary set of steps 200 for activating the smartphone 12 to operate using an exemplary activation unit 15.

The activation commands, stored in memory 24 of the activation unit 15, are defined at step 210. For instance, the activation keyboard commands may be configured by the smartphone 12 using its consumer control key descriptor setup 22 so that the keyboard commands are associated with a desired action on the smartphone, and then this keyboard command configuration data is sent wirelessly to the activation unit 15 using the Bluetooth interface 16a to the Bluetooth interface 16c. App 22 may provide the option of defining multiple sequences of keyboard commands when the activation unit 15 has multiple buttons 27 (or the button may receive multiple forms of input, e.g. a long press or a short press of the button), so that each of the buttons 27 sends a specific sequence of keyboard commands to cause respectively a specific action on the smartphone 12. It will be understood that there may be other ways of defining the sequence of keyboard commands aside from using consumer control key descriptor setup 22.

Once the activation unit 15 receive the keyboard commands, the keyboard commands are sent via the Bluetooth interface 16c to memory 24 for storage at step 220. Activation is started by, for instance, the user pressing the activation button 27 at step 230.

The consumer control key transmission module 26 receives a signal from the activation button 27 indicating that the activation button 27 has been pressed. The consumer control key transmission module 26 retrieves and reads from memory 24 the keyboard command data associated with the pressed button 27 at step 240. When the activation unit 15 has multiple buttons 27, the consumer control key transmission module 26 determines first, for instance, by analyzing the metadata for each sequence of keyboard command data in memory 24, which sequence of keyboard commands is associated with the given pressed button 27. For instance, the metadata may define an integer for each of the activation buttons 27 that may be verified by the consumer control key transmission module 26 when retrieving the corresponding keyboard commands.

In some examples, the activation unit may be configured so that a different sequence of keyboard commands is outputted depending on the number of times the user presses the button during a specified period. For instance, if the user presses the button once in the space of two seconds, a first set of keyboard commands may be sent. However, if the user presses the button twice within two seconds, then the activation unit 15 may be configured to send a second sequence of keyboard commands. In other embodiments, the activation unit 15 may be configured to send a different sequence of keyboard commands depending on the duration of the pressing of the button of the activation unit 15 by the user. For instance, if the user performs a quick press of the button (e.g. under 0.5 seconds), a first set of keyboard commands may be sent, where if the user performs a longer press of the button (e.g. 2 seconds or more), a second set of keyboard commands may be sent.

Once retrieved, the consumer control key transmission module 26 transmits the sequence of keyboard commands to the Bluetooth interface 16c. The Bluetooth interface 16c then transmits the sequence of keyboard commands to the Bluetooth interface 16a of the smartphone 12 via the Bluetooth connection at step 250.

In the example of an iOS device, the keyboard commands, once received, may be directed to first activating the application program AssistiveTouch™ on the iOS device. AssistiveTouch™ is an application program for assisting a user in the controlling of the iOS device, such as in the performance of certain gestures (e.g. pinch, multi-finger swipe) and providing a shortcut for accessing certain features of the iOS device (e.g. the Control Center, Siri). In some examples, as a result of Apple's MFi licensing program, the user may be prompted by the iOS device to select to “allow” or “don't allow” activation of AssistiveTouch™. The user only has to select, with, for instance, touching the appropriate location on the screen of the smartphone 12 to “allow” so that AssistiveTouch™ is activated at step 260. In some examples, it may be necessary for the user to select “Allow” or “Don't Allow”. Once the AssistiveTouch™ application program is activated, AssistiveTouch™ may be configured in such a way that a cursor appears on the screen of the iOS device. The keyboard commands received by the iOS device from the activator unit 15 are then processed by the iOS and AssistiveTouch™ to perform the desired actions associated with the keyboard commands by prompting the AssistiveTouch™ cursor to navigate and press when needed, the actions of the AssistiveTouch™ cursor dependent upon the sequence of keyboard commands at step 270. The desired actions are then carried out without the user having to provide any further input to the smartphone 12. These illustrations are not limitative and are but examples of how AssistiveTouch™ application program may be used in accordance with teachings of the present invention.

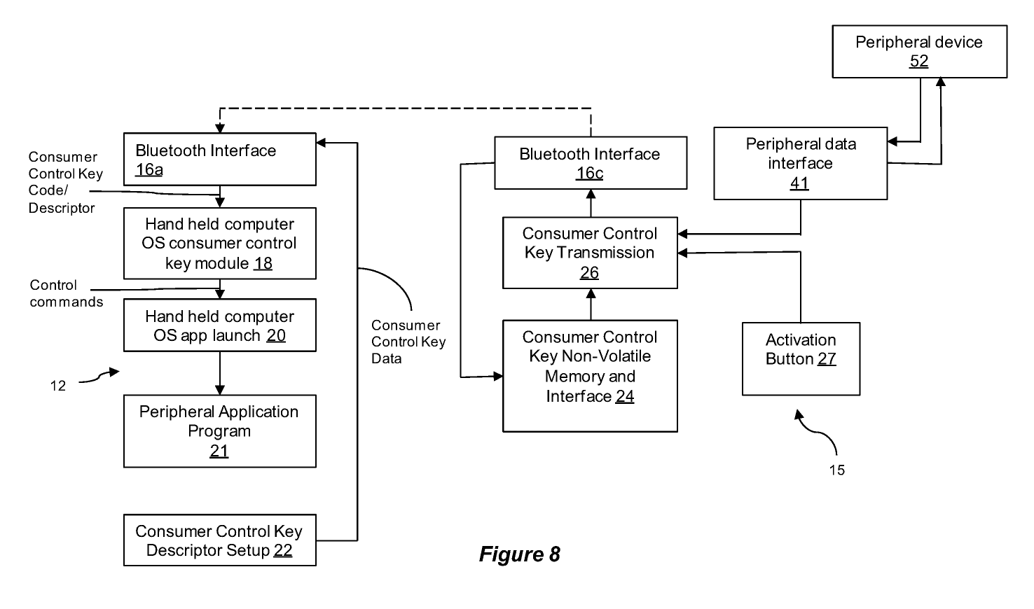

As mentioned above, the activator unit 15 and the Bluetooth connection between a peripheral device (such as in the example of FIG. 8) and the iOS device and/or between the activator unit 15 and the iOS device may be MFi enabled (the MFi program is a licensing program run by Apple where hardware and software peripherals are enabled to run with Apple™ products, such as the iPhone and iPad).

In the context of a store environment in which customers are given tablet computers for a task, such as giving their data to open an account or conclude a purchase, it can be desirable for unit 15 to operate with more than one smartphone 12. In this case, the wireless interface 16c is adapted to be able to link with multiple devices. The app 21 can also be configured to signal to unit 15 when a customer or user of the smartphone 12 (likely a tablet computer) is done entering information or completing a task. This signal can be done using the same wireless channel or a separate channel. It will be appreciated that this ability for one unit 15 to control and in effect monitor the use of a number of smartphones 12 (likely tablet computers) can be applicable to classroom settings and many other contexts.

Another example of the use of pre-defined operations that can be stored in association with a button 27 relates to the use of the smartphone in a motor vehicle with certain apps that require user input, such as a GPS navigator that may require an address to be input. A button 27 can be used for causing the smartphone 12 to make it easier to input text. For example, there can be a dedicated button 27 to launch a map app 21m (not shown in the drawings, ‘m’ is for map), such as Google Maps or Apple Maps, however, instead of the user touching the smartphone's screen to begin entering an address with the standard on-screen keyboard, a dedicated button 27 (or a special press, like a double-tap, of the same button 27 used to launch the map app 21m) is used to cause a special keyboard to be used. Then, a button 27 (or other input from the user) of unit 15 can be used to send keyboard commands to enter settings and cause the smartphone 12 to switch its keyboard to a keyboard that is either larger or more easy to use. For example, in an iOS device, the MyScript Stylus app available at the iStore causes an iOS device to install a third party keyboard called Stylus that allows finger strokes to be recognized for entering characters. Unit 15 can also be used to cause the smartphone 12 to change back the keyboard to a standard keyboard. If the smartphone has an option in settings to cause a standard keyboard to be enlarged or to be otherwise special, commands for engaging such settings can be issued. A custom keyboard can provide a smoother user experience. It can be configured to provide voice feedback, for example to play a recording of “A as in apple” when the character ‘A’ is entered. It can also provide an enlarged pop up display of the character entered that can then fade after display.

Alternatively, the activator unit 15 can send keyboard commands from memory 24 through transmission module 26 to bring to the surface a special keyboard app 21k (not shown in the drawings, ‘k’ is for keyboard), and this app 21k can provide a full screen keyboard with keys that are about 4 times larger than usual such that almost the full screen is taken up with the keys, leaving a small portion for the text being typed. The size of the on-screen keyboard can be adjustable. In this embodiment, the return to the map app with the desired text now typed in can be done in a number of ways. In addition to using enlarged keys, finger stroke character recognition can be used to input letters, numbers or symbols instead of keyboard keys. Audio feedback as each character is entered can be provided to help a user enter text. A display of the character entered as a full-screen image and then fading away can also be provided to signal to the user that the character has been entered.

Firstly, the app 21k can place the desired text in the copy buffer so that the app 21m can access it from the copy buffer, for example by the user issuing a paste command. In this case, the switch from app 21k to app 21m can be done by the user on the smartphone 12, or using the button 27 that calls up app 21m. Secondly, the app 21k can send a command to unit 15 over the same wireless channel used for the keyboard, or using a different channel, to cause the unit 15 to send keyboard commands to the smartphone 12 to switch to app 21m. In this case, there are two options for transferring the text entered by the user, either by the copy-paste buffer or by sending the text from app 21k to the unit 15 for storing temporarily unit the unit 15 causes the smartphone 12 to switch back to app 21m, and then unit 15 will “type” back the text in app 21m that was entered in app 21k.

A third option is more complex, however, it can be more seamless for the user provided that the response time of the smartphone 12 is sufficiently fast. Unit 15 and app 21k can work together to provide the appearance of remaining in app 21m while effectively remaining within app 21k for keyboard input, as illustrated in FIG. 3. For example, unit 15 can issue keyboard commands to smartphone 12 to call up app 21m, take a screen shot that is placed in the copy buffer, and then unit 15 calls up app 21k. App 21k then reads the copy buffer and displays it in the background with the enlarged keyboard or finger stroke recognition interface in overlay over the background. Each time a character is entered in app 21k, app 21k could signal to unit 15 to send keyboard commands to smartphone 12 to switch over to app 21m, send the character as a keyboard entered character in app 21m, take a screenshot to the copy buffer, and switch back to app 21k. App 21k would then read the copy buffer image and use it for the updated background image, so that the user sees the newly-typed character appear in the image of app 21m. This can give the user the illusion of being in app 21m the whole time, albeit with a modified interface for the enhanced keyboard and/or the stroke recognition.

While not illustrated in FIG. 3, app 21k can include a “hide/stop keyboard” button that the user can use to cancel the operation of app 21k and unit 15 to provide the special keyboard functionality, or a button 27 can be pressed to perform the cancel. While more complex still, app 21k and/or unit 15 can be configured to recognize from the screen image of app 21m (app 21m can be in this context a non-map app as it is the target app that makes use of the special keyboard) the state of app 21m to determine whether app 21k and the coordinated effort of unit 15 for providing keyboard functionality can be terminated. This can allow app 21m to proceed without any interruption from the special keyboard control.

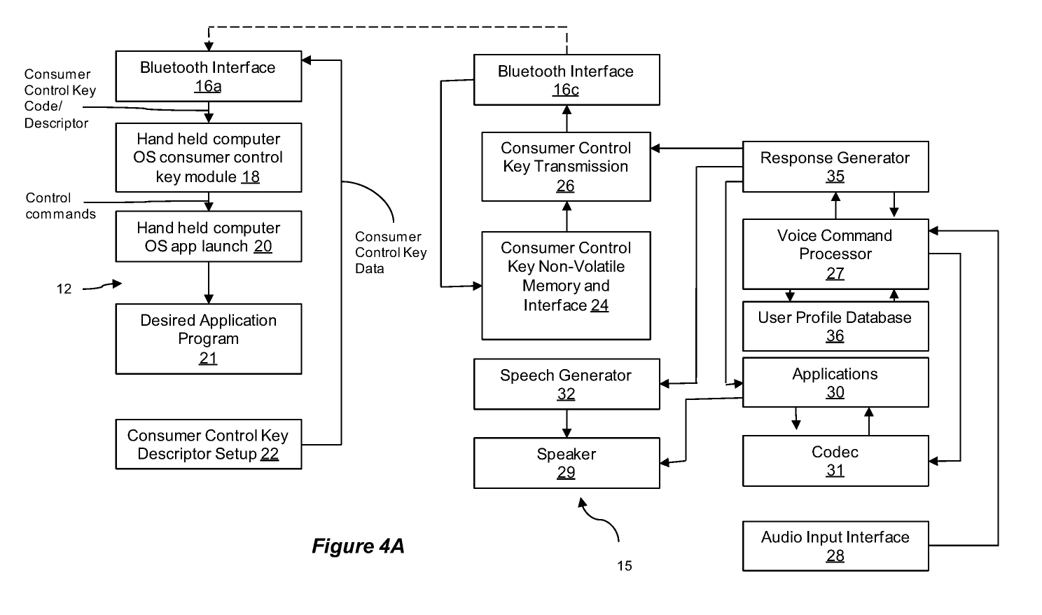

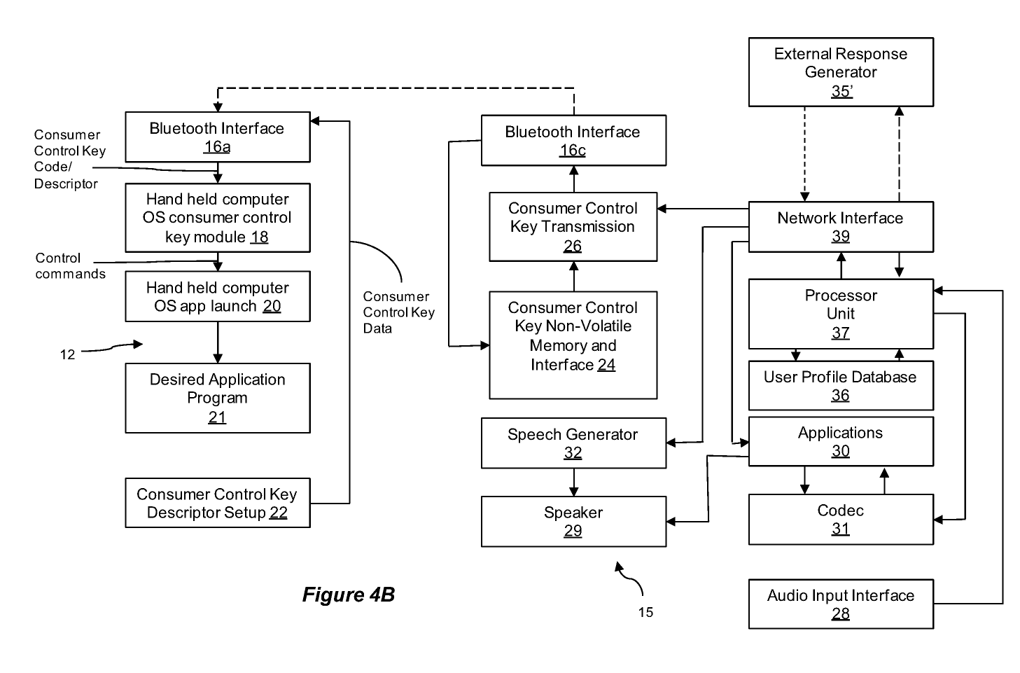

Reference is now made to FIGS. 4A and 4B showing an activation unit 15 acting as a speech-controlled device for receiving voice commands and processing these into keyboard commands transmitted to a smartphone 12. The activation unit 15 may not only provide an audio response to a speech command expressed by a user, but may also allow the control of the computing device 12 of the user to provide on its display a visual representation of the answer (e.g. a location on a map; a photograph; a restaurant review). The computing device 12, controlled by the activation unit 15, may be, for example, an Apple iPhone® or iPad® operating under the iOS, where the operating system's application programs exist in a sandboxed environment or otherwise prevents an app from controlling settings or other apps to perform actions that normally only a user can do. The activation unit 15 may use keyboard commands, sent to and received by the computing device 12, to command the computing device 12 and to perform tasks that an app is not permitted, as described herein with reference to the activation unit 15, applicable with respect to the activation unit 15.

The activation unit 15 has an audio input interface 28, at least one speaker 29, a voice command processor 27 and a response generator 35. The activation unit 15 also has a consumer control key transmission module 26, a memory 24 and an external output interface 16c. The activation unit 15 may have a speech generator 32 and application programs 30. The activation unit 15 may also optionally have at least one codec 31 and a user profile database 36. The activation unit 15 implements the teachings of the voice interaction computing device, system and architecture of U.S. Pat. No. 9,460,715, entitled “Identification Using Audio Signatures and Additional Characteristics”.

The activation unit 15 may have computer readable memory that is for storing computer readable instructions and that are executable by a processor. Such memory may comprise multiple memory modules and/or cashing. The RAM module may store data and/or program code currently being, recently being or soon to be processed by the processor as well as cache data and/or program code from a hard drive. A hard drive may store program code and be accessed to retrieve such code for execution by the processor, and may be accessed by the processor 120 to store, for instance, keyboard command data instructions, application programs, music files, etc. The memory may store the computer readable instructions for the response generator 35, the consumer control key transmission module 26, the speech generator 32 and the application programs 30. The memory may also store the user profile database 36 and, the at least one codec 31 when such is software. In some examples, the codec 31 may be hardware (e.g. graphics processing unit), or a combination of both.

The activation unit 15 may also have one or more processing units, such as a processor, or micro-processor, to carry out the instructions stored in the computer readable memory (e.g. the voice command processor 27 of FIG. 4A, or the processing unit 37 of FIG. 4B).

The audio input interface 28 may be, for example, one or multiple microphones for picking up on surrounding audio, including speech expressed by a user.

The voice command processor 27 is configured to receive the audio data from the audio input interface 28, and analyze the audio data received by the audio input interface 28, such as by performing speech recognition to identify and analyze, for example, speech vocalized by a user. The voice command processor 27 may be one as is known in the art. The voice command processor 27 may also be attentive to certain key trigger words, such as “Alexa™” or Google™, acting as a signal that the speech subsequent to the key trigger word will likely be a speech command (e.g. “Alexa, where is the closest movie theatre?”; “Google™, what is the currency rate between US dollars and Euros?”).

The voice command processor 27 may also access a user profile database 36 to further analyze the speech of the user. The user profile database 36 may contain information on a number of user profiles. For instance, this information may include, for a user profile, days on which the user often issues voice commands, a vocabulary typically used by the user, a language spoken by the user, pronunciation and enunciation of certain words by the user, and commands often issued by the user. This information on the user found in the user profile database 36 may be further accessed by the voice command processor 27 to assist with the identification of the user or to confirm the identity of the user.

The response generator 35 receives the recognized voice command of the user from the voice command processor 27 and analyzes the voice command to provide an appropriate response. Such a response may be to send out an audible answer to the voice command, such as when the command is phrased as a simple question. The response generator 35 may also launch an application program 30. The application program 30 can be launched to carry out a designated function or response associated with the user's speech command. The application programs 30 may be, for example, an audio player to output audio via speaker 29, or an application program that allows a user to place and answer telephone calls at the activation unit 15. For instance, the response generator 35 may send out a response command to launch the media player application program 30 when the user asks “Google, play Beethoven's Ninth Symphony”, and Beethoven's Ninth Symphony can be streamed by the activation unit 15, or is stored in memory 24 of the activation unit 15 as part of the user's music library contained in the activation unit 15.

The response generator 35 may also trigger as a response the sending of keyboard commands. The response generator 35 calls the consumer control key transmission module 26 to send a series of keyboard commands appropriate with the voice command. The consumer control key transmission module 26 may retrieve the appropriate keyboard commands from memory 24, and sends same to the computing device 12 via the Bluetooth interface 16c. The keyboard commands may cause, for example, the unlocking of the computing device 12, the launching of the desired application program 21, or the performance of a desired function of the desired application program 21. For instance, the keyboard commands may type an address into a map application program, then, the voice-controlled device 40 may signal the user (such as via an audio signal transmitted via the speaker 29) to view the display of its computing device 12. The keyboard commands allow for the control of the computing device 12 to provide the user with a visual response to the user's speech command, the visual response appearing on, for instance, the display of the computing device 12.

The speech generator 32 is as is known in the art that formulates an appropriate audio signal (e.g. a string of words) in accordance with the instructions received from the response generator 35. The speech generator 32 then sends the audio data of the appropriate audio signal to the speaker 29 so it may be shared audibly with the user.

The activation unit 15 may have one or more codecs 31 for encoding or decoding audio signals. For instance, the activation unit 15 may have stored in memory, or may stream, compressed audio files (e.g. MPEG-4, MP3) corresponding to musical recordings. The codecs 31 may decompress these audio files, so that a designated application program 30 may transmit the decompressed audio signals to the speaker 29 so that they may be played.

The activation unit 15 may also receive consumer control key data from the computing device 12 via the Bluetooth interface 16c. The data may be stored in memory 24.

In some embodiments, the response generator 35 is integrated into the activation unit 15 (e.g. as software stored in the computer-readable memory). In other embodiments, as illustrated in FIG. 4B, the response generator 35′ may be remote, such as on an external server. In these examples, the activation unit 15 may have a network interface 39 for establishing either a wired, or wireless connection (e.g. WiFi connection) with the external response generator 35′. The network interface 39 may be a transceiver (or a transmitter and a receiver). The processed voice commands may be sent via the network connection to external response generator 35′. The external response generator 35′ may send an interactive response in the form of information back via the network connection to the network interface 39. The network interface 39 relays the response to the processing unit 37 that processes the response to produce the requisite action (e.g. an audio answer, calling an application program of the activation unit 15 or sending keyboard commands to the computing device 12 to cause it to display an answer to the user). The processing unit 37 may also have the voice processing qualities as the voice command processor 27.

The keyboard commands that correspond to specific actions can be stored in memory 24.

For example, if the activation unit 15 incorporates a device like an Amazon Echo™ device that operates with the Alexa™ app on an iPad or an iPhone device using the iOS operating system, keyboard commands can be issued by the activation unit 15 to cause the iOS computer to launch the Alexa app (or equivalent) using keyboard commands as described above so as to allow the Echo device (or equivalent, such as the Google Home device) to connect to the Internet using the Bluetooth connection (or equivalent) of the Echo device and the Internet connectivity of the iOS device. Therefore, the activation unit 15 may be a portable speaker device like the Amazon Echo™ device with the keyboard command features described herein. In addition to the activation unit 15 commanding the iOS device to run an app for the activation unit 15, a voice command can be interpreted and used to control the iOS device to do almost any operation or function, like command the playing of music with the selection of Bluetooth audio output without requiring the user to manually control the iOS device. Furthermore, when a voice request received by activation unit 15 can best be answered by the iOS device opening a given app and then functioning with particular parameters, activation unit 15 can command the iOS device accordingly using keyboard commands. For example, the activation unit 15 might cause the iOS device to open a map or navigation app and input an address for a destination to be reached in response to a voice command, and then inform the user to look at the iOS device.

In another example, a voice request received by the activation unit 15 may be directed to making a phone call. In this instance, once the voice commands to make the call are received by the activation unit 15, the activation unit 15 can use keyboard commands to command the iOS device to unlock, to ensure that the audio settings on the device 12 are set to use the Bluetooth device for the conversation (e.g. the one associated with activation unit 15), to open the application program on the iOS device used to place a call, such as the “Phone” app, and then send a series of keyboard commands to the iOS device to place the call. For instance, the user may make the voice request to “call Dad”. If the activation unit 15 does not recognize from the data available to it who “Dad” is, it can issue keyboard commands to the device 12 to open the Phone app, and possibly search through the contacts or the configurations stored in memory on the iOS device for the number associated with “Dad”. It can then tell the user to look at the screen of the device 12 to select the number to call if available. Once the call is placed, the Bluetooth connection between the iOS device allows for audio transmission between the handheld speaker, such as the Amazon Echo™, and the device, establishing communication between the parties on the call.

In another example, the user's voice request received by the activation unit 15 may be to add, for instance, a meeting to the user's calendar at a given time and date, the calendar located on the user's iOS device. The activation unit 15 sends the corresponding keyboard commands to open the “Calendar” app on the iOS device and add the meeting to the calendar in the desired timeslot. In the case where there exists a conflict in the user's schedule on the calendar, the user may, for example, receive the notification of the conflict in the user's schedule via a message appearing on the user's iOS device.

Alternatively, interface 39, or an additional data interface of the activation unit 15 (e.g. a Bluetooth data interface) can be used to receive control commands from a network service and relay them to module 26 to control the device 12. The remote command network interface 39 may receive said voice commands from, for example, a handheld speaker controlled through voice commands such as the Google Home or Amazon Echo™. For example, when the voice commands received by the handheld speaker are directed at carrying out a desired action on the user's smartphone 12, the handheld speaker will transmit the voice commands to the remote command network interface 39 (which can be, for example, a Bluetooth interface for establishing a Bluetooth connection or a wireless interface for establishing a WiFi connection). The remote command network interface 39 may channel these commands to the voice command processor 27 which will process the voice commands (via the response generator 35) into keyboard commands recognized by the smartphone, the processing done in function with the processing instructions stored in memory and/or received by the consumer control key non-volatile memory and interface 24. The keyboard commands are then sent by the transmission module 26, using the activation unit 15's Bluetooth interface 16c, to the smartphone's 12 Bluetooth interface 16a, via an established Bluetooth connection. The keyboard commands are then processed by modules 18 and 20 of the smartphone's 12 OS, resulting in the smartphone 12 carrying out the desired action in accordance with the voice commands. Therefore, in some embodiments, the keyboard command emitting components of the activation unit 15 may be integrated into the portable speaker such as the Amazon Echo™, while in others the keyboard command emitting components of the activation unit 15 may be separate, but configured to interact with the portable speaker.

In one illustrative example, the user may ask the activation unit 15 to locate the nearest Japanese restaurant with respect to a specific location. The processing unit 37, receiving the audio input from the audio input interface 28, may send the voice command to the external response generator 35′. The external response generator 35′ may process the request and send back the answer, in the form of data corresponding to a string of characters representing the name and address of the restaurant. The external response generator 35′ may also send the activation unit 15 command input to access the map application program of the computer 12 and enter into the map application program a string of characters representing the name of the restaurant. The activation unit 15 processes the command input, using the consumer control key transmission module 26, and sends the corresponding keyboard commands to the computer 12 via the Bluetooth interface 16c. The computer 12 receives the keyboard commands via its external keyboard interface 16a, and the computer's OS and/or modules 18 and 20 launch the map application program 21 and enters the characters of the name of the restaurant. In some examples, the user may be sent a message to view the screen of his computer 12, or keyboard commands to take a screen capture may also be sent by the activation unit 15 and processed by the computer 12 (taking a screen capture of the map displaying the location of the restaurant). The external response generator 35′ may, in some examples, send a sequence of keyboard commands directly over the connection between established with the data interface 39, this sequence of keyboard commands relayed via the Bluetooth interface 16c to the computing device 12.

In an alternative embodiment of FIG. 4A or FIG. 4B, the mic or speaker receiving the voice commands may be integrated into the activator unit 15. The person having ordinary skill in the art will readily recognize that any mic or device for receiving voice commands may be used without departing from the teachings of the present invention.

Furthermore, in another alternative embodiment of FIG. 4A or FIG. 4B, the remote command network interface 27e may receive instead commands in the form of gestures (these commands sent, for example, by a motion sensor or optical sensor for converting motion information into data), such as hand gestures or body signals, these gestures then processed by the activator unit 15 into keyboard commands in accordance with the teachings of the present invention. In other embodiments of FIG. 4, other forms of signals may be processed by the activator unit 15 into keyboard commands, such as heat signals (e.g. by the measurement of infrared radiation), vibrations using, for example, a vibration sensor, humidity (e.g. using a humidity sensor) or light (e.g. using a light sensor) without departing from the teachings of the present invention.

Background User Input Detection Program:

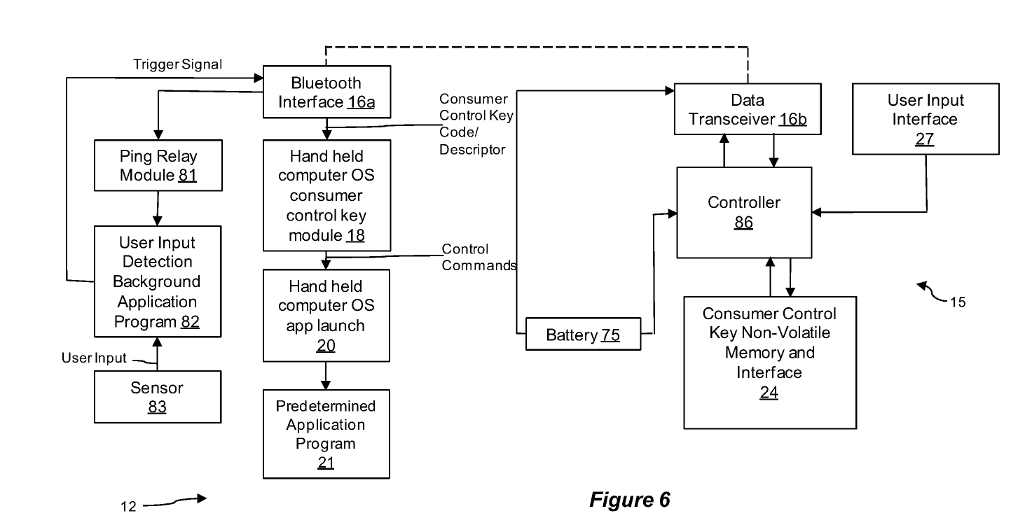

FIG. 6 illustrates an exemplary activation unit 15 for controlling a computing device 12. The computing device 12 has a user input background application program 82 for detecting user input, where specific user input is indicative of a user's desire to activate a predetermined application program 21 on the computing device 12. Once the user input background application program 82 detects the specific user input, the input background application program 82 transmits a trigger signal. The trigger signal is sent over a data connection, for instance, via a wireless connection (e.g. Bluetooth connection) or a wired connection to the data transceiver 16b of the activation unit 15. Once received, the data transceiver 16b transmits the trigger signal to the controller 86. The controller 86, in response, transmits a sequence of keyboard commands over the data connection between the computing device 12 and the activation unit 15. The sequence of keyboard commands is processed by the OS (and its modules 18 and 20), and the sequence of keyboard commands causes the launch of the predetermined application program 21.

The activation unit 15 has a controller 86, memory 24 and a data transceiver 16b. The activation unit 15 may also have a battery 75 and a user input interface 27.

The user input interface 27 is an interface for receiving user input. The user input interface 27 may be a button, several buttons, a motion sensor, a speaker combined with a voice command processor (for receiving speech commands), or any other interface for detecting a form of input from a user or from an environment (e.g. sunlight, heat, humidity, vibrations).

The controller 26 may be a microprocessor (such as a MSP430F5254RGCT) that includes non-volatile memory 24 (including the configuration memory). Non-volatile memory can also be provided using a component separate from the microprocessor. Some models of microprocessors may include a Bluetooth wireless transceiver 16b, while a separate component for such a wireless transceiver (Bluetooth or otherwise) can be provided using a separate IC component (for example, a BLE0202C2P chip and/or a CC2564MODN chip). In some embodiments, the activation unit 15 may have two Bluetooth transceivers, one with BLE (Bluetooth Low Energy) technology, and the other with Bluetooth Classic technology.

The data transceiver 16b may be a transmitter or receiver for sending and receiving data over an established connection. For instance, the data transceiver 16b may establish a wired connection with the computing device 12. In other examples, the data transceiver 16b may be a wireless data transceiver, establishing a wireless connection with the computing device 16b, such as a Bluetooth connection, where the data transceiver 16b is a Bluetooth transceiver. In some examples, the Bluetooth transceiver 16b is a Bluetooth chip. In some embodiments, the Bluetooth transceiver 16b is connected to the battery 75 (and in some examples, connected to the battery 75 via the power circuit 84), and receives power from the battery 75. The Bluetooth transceiver 16b may be a Bluetooth Low Energy Chip, integrating the BLE wireless personal area network technology or Bluetooth Smart™. The Bluetooth transceiver 16b is also configured to send a ping or signal to the smartphone 12, once the activation unit 15 is paired with the smartphone 12. The Bluetooth transceiver 16b also receives a trigger signal from the smartphone 12 via the wireless connection to cause the controller 86 to send keyboard commands to launch the predetermined application program 21.

In other embodiments, the wireless transceiver 16b may be a wireless USB transceiver.

Consumer control key non-volatile memory and interface 24 is computer readable memory that may store the keyboard commands for running the predetermined application program 21 or to cause other actions on said computing device 12 (e.g. unlocking the computing device 12, running an application program on the computing device 12), and instructions that are readable and may be executed by the controller 86, that may function also as the consumer control key transmission module 26 (e.g. memory may store one sequence of keyboard commands associated with one task, or multiple sequences of keyboard commands, each associated to at least one task such as unlocking the smartphone 12, searching for the application program 21, running the application program 21). The consumer control key interface 24 may also be configured to receive wirelessly command key configuration data from the smartphone 12. The command key configuration data may provide information on the sequence of keyboard commands to be stored. Therefore, the smartphone 12 may send information to the activation unit 15 regarding the sequence of keyboard commands to be used. Such may be practical, for instance, when the password to unlock the smartphone 12 changes. The new sequence of characters to unlock the smartphone 12 may be sent by the smartphone 12 to the consumer control key non-volatile memory and interface 24 in the form of command key configuration data, the sequence of keyboard commands stored in consumer control key non-volatile memory and interface 24 updated as a result.

The battery 75 may be that as is known in the art. The battery 75 may be rechargeable.

Method of Running a Predetermined App on Computing Device and Detecting User Input on Computing Device:

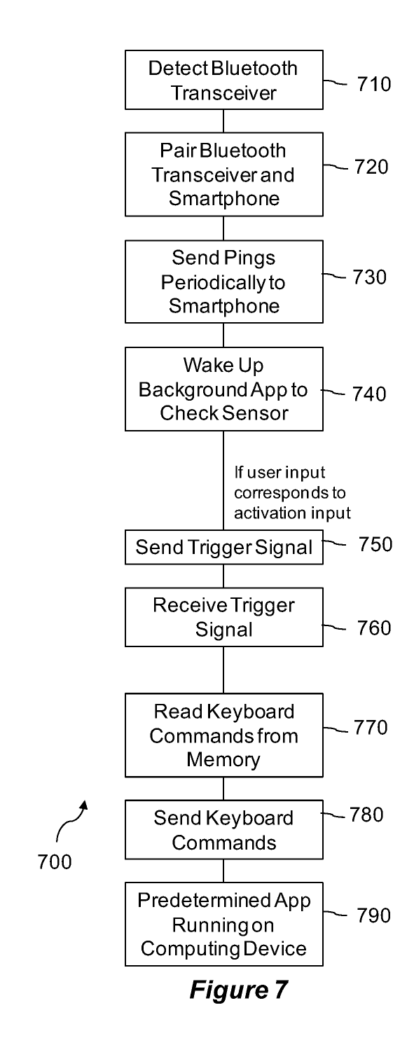

Reference is now made to FIG. 7, illustrating an exemplary method 700 of causing the smartphone 12 to run a predetermined application program 21 after receiving specific user input on the smartphone 12 (or any other computing device, such as e.g. a tablet).

The smartphone 12 first detects the Bluetooth transceiver 16b of the activation unit 15 when the smartphone 12 is in range of the Bluetooth transceiver 16b at step 710. The Bluetooth transceiver 16b may be operating with Bluetooth Low Energy (BLE) technology. Once the Bluetooth transceiver 16b is detected by the smartphone 12, using, for instance, geofencing between the smartphone 12 and the Bluetooth transceiver 16b, the Bluetooth transceiver 16b is paired with the smartphone 12 at step 720, establishing a wireless Bluetooth connection between the smartphone 12, via its Bluetooth interface 16a, and the Bluetooth transceiver 16b.

In some embodiments, once the Bluetooth transceiver 16b is paired with the smartphone 12, the Bluetooth transceiver 16b starts sending signals (e.g. pings) periodically to the smartphone 12, to its Bluetooth interface 16a at step 730. In one embodiment, the Bluetooth transceiver 16b sends a ping every second. The pings are received by the Bluetooth interface 16a, transmitted to the iOS of the smartphone 12 and processed by the iOS. The smartphone 12 has a user input detection background application program 82 for periodically verifying if the user has provided input that corresponds to user input indicating the user's desire to activate the activation unit 15. The activation user input may be defined by the user or pre-configured when the background application 82 is added to the smartphone 12. The background application program 82 may be configured to verify user input data transmitted from a specific sensor 83 of the smartphone 12 (or the background application 82 is configured to retrieve the data from the sensor 83). In some embodiments, the sensor 83 may be or include the camera of the smartphone 12, where the background application program 82, in response to the pings, may receive (and/or retrieve) and may periodically verify the stream of images produced by the camera for certain features that could be desired user input, such as activation user input.

In some examples, the sensor 83 in question that is verified by the background application program 82 may be the proximity sensor of the smartphone 12. The proximity sensor, as is known in the art, is able to detect the proximity of nearby objects without any physical contact. The proximity sensor of the smartphone 12 is used to detect when a user's face is near the smartphone 12 during the call in order to avoid performing acts associated with undesirable user taps of the display screen of the smartphone 12 during a call (such as one caused by an ear pressing the screen of the smartphone 12). In some smartphones, the proximity sensor is located at the top of the smartphone.

The proximity sensor may register when an object is in proximity of the smartphone 12, such as a hand positioned over a certain portion of the smartphone 12. If the proximity sensor is located at the top of the smartphone 12, positioning a hand over the top of the smartphone 12 is registered by the proximity sensor. Therefore, after the background application program 82 is woken up by a ping, it may be configured to verify if the proximity sensor has detected as user input a hand near the proximity sensor, or a sequence of an object coming in and out of range of the sensor, such as a sequence consisting of a hand coming into range of the proximity sensor, and then out of range, followed by the hand coming back into range. It will be appreciated that any combination of hand movements (or other movements of the body or of an object) that can be detected by the proximity sensor may be used as activation user input, then retrieved by or transmitted to the background application 82.

In other examples, the sensor 83 may be an accelerometer of the smartphone 12 as is known in the art, measuring changes in velocity (e.g. vibrations) of the smartphone 12. As such, the user input indicative of the user's desire to activate the activation unit 15 may be a double-tap of the frame of the smartphone 12, picked up by the accelerometer. Preferably, the activation user input is selected as one that can be distinguished from those used to activate or function other common application programs found on the smartphone 12.

Moreover, the background application 82 may be configured to declare that it supports a Core Bluetooth background execution mode in its Information Property List (Info.plist) file. Therefore, in some embodiments, as the background application 82 is declared as being Bluetooth sensitive, once a ping is received by the smartphone 12 from the Bluetooth transceiver 16b, the iOS wakes up the background application 82 at step 740. The background application 82 stays awake for a certain time following being woken up, and verifies the user input data received from the accelerometer. However, as the pings are sent periodically to wake up the background application 82, each ping keeps, in some embodiments, the background application 82 awake. The background application 82 may include a detection algorithm for analyzing the user input data in order to identify activation user input (e.g. by logging in the user input data, comparing against the other forms of user input registered by the smartphone 12, and/or identifying if it is comparable to the activation user input). In some embodiments, if the user input data matches the activation user input, then the background application 82 sends a trigger signal to the Bluetooth transceiver at step 750. The trigger signal can be defined as, when the activation user input is a double-tap on the frame of the smartphone:
<Trigger>
<Source>double tap on the phone</Source>
</Trigger>
or it can be very a binary hex as 2 bytes, where the first byte defines a command and the second the source of the commands, for instance:
0x01—trigger
0x03—double tap on the phone.

In some embodiments, the trigger signal is sent to the Bluetooth transceiver 16b via the Bluetooth interface 16a, communicated through the Bluetooth connection established between the smartphone 12 and the Bluetooth transceiver 16b.

In some embodiments, the background application 82 does not identify if the user input corresponds to the activation user input, instead sending all of the user input received from at least one of the smartphone's sensors to the Bluetooth transceiver 16b (e.g. in the form of a binary hex identifying the type of user input). The Bluetooth transceiver 16b may have an analyzing function for analyzing the user input data received and comparing it with specific activation user input data (e.g. if the Bluetooth transceiver 16b receives a binary hex, the binary hex is compared to establish if it corresponds to that leading to the trigger signal to send out the keyboard commands to cause the activation of the predetermined application program 21).

The Bluetooth transceiver 16b receives a trigger signal at step 760. The trigger signal is sent to the controller 86. Having received the trigger signal, the controller 86 retrieves and reads from non-volatile memory 24 a sequence of keyboard commands at step 770. In some embodiments, the sequence of keyboard commands to launch the predetermined application program 21 may be preceded by the sending of at least one character to the smartphone 12 for lighting up the smartphone 12, followed by the sequence of keyboard commands for unlocking the smartphone 12 and running the viewing application program 21. In other embodiments, the sequence of keyboard commands may be limited to those for running the application program 21.

The controller 86 then transmits the sequence of keyboard commands to the Bluetooth transceiver 16b. The Bluetooth transceiver 16b transmits the sequence of keyboard commands via the Bluetooth connection to the Bluetooth interface 16a of the smartphone 12 at step 780. The data of the sequence of keyboard commands are processed by modules 18 and 20, and the iOS carries out these commands to, optionally unlock the phone, then search for the predetermined application program 21, and run the predetermined application program 21.

In the case where the activation unit 15 adheres to Apple's MFi licensing program, the user may be required to select an “allow” button that appears on the display of the smartphone 12 to run the predetermined application program 21. Touching the portion of the screen corresponding to the “allow” button may allow the user to run the viewing application program 21. In other embodiments, the pressing of “allow” button may be performed using the AssistiveTouch™ application program of the iOS.

The predetermined application program 21 is then running on the smartphone 12 at step 790.

The background application program 82 may be turned off on the smartphone 12, requiring that it is turned on before use. In some embodiments, the BLE-based Bluetooth transceiver 16b may function as a beacon for the smartphone 12. Using geolocation, once the smartphone 12 is in range of Bluetooth transceiver 16b, the background application program 82, having a permission to use the geolocation service, is turned on by the OS of the smartphone 12. Once the smartphone 12 moves out of range of the Bluetooth transceiver 16b, the OS of the smartphone 12 turns off the background application program 82. In other examples, the user may manually turn on the background application program 82 or manually turn off the background application program 82, receiving, for instance, a warning in the form of a message when the background application program 82 is to be or has been turned off.

Exemplary Uses of the Activation Unit:

The following examples are for illustrative purposes of the activation unit and are not meant to limit the scope of the applicability of the activation unit. It will therefore be appreciated that the activation unit may be used for many other applications than those described herein.

### Example 1: Activation Unit for Assisting with the Taking of a Screenshot

For instance, when taking a screenshot using certain smartphones such as an iPhone, multiple buttons may be required to be pressed simultaneously. In the case of an exemplary iPhone®, the taking of a screenshot requires the simultaneous pressing of the “Home” button and the power button. However, this pressing may be challenging when the user's hands are not free, and/or when, for example, it may be illegal and/or dangerous to handle the smartphone, such as when driving. Nevertheless, timely pressing of the iPhone® may be desirable for the user, such as when the user is streaming music and wishes to capture the song information (e.g. title, artist) that appears on the screen.

As a result, the pressing of a button on the activation unit that triggers the sending of a series of keyboard commands by the activation unit to the smartphone, allows the user to take a screenshot without having to perform any simultaneous pressing of buttons on the smartphone or handle the smartphone. The sequence of keyboard commands sent to the smartphone are processed by the smartphone to carry out the taking of the screenshot.

### Example 2: Activation Unit to Assist with a Copy and Paste Function

The activation unit may assist with copying and pasting information on the smartphone such as by the press of a single button on the activation unit. Copying and pasting usually requires multiple steps that may be time consuming for the user. Moreover, the user may desire to translate the text to be pasted (or simply translate a text for its own understanding).

The keyboard commands issued by the activation unit when a button is pressed may be configured to perform the following exemplary steps on the smartphone (e.g. an iPhone®) with a when the smartphone has received and processed the keyboard commands:
Copy the highlighted the text
Open Google translator app
Choose input language as French
Choose output language
Paste text in input field
Text is instantly translated in output field
Press side arrow icon to display English text in an action text box
In the action text box press the copy icon
Open the Notes app
Press the New Note Icon
Paste the translated text

It will be appreciated that the activation unit may be configured, in some examples, to perform all or only a part of the above steps (e.g. when only a translating feature is desired for a text that has been copied, or when only the copy-paste steps are desired without the translating).

### Example 3: Activation Unit to Perform Control Media Playback on a Smartphone while Driving

In some embodiments, the user may desire to navigate more easily through a media playback application program on a smartphone, such as an audio player or an audiobook. However, such navigation may require multiple steps, such as unlocking the smartphone, accessing the application program (that may be playing in background mode—not in foreground mode), and press the desired icons on the screen to perform the desired actions (e.g. fast forward by a certain amount of time, pause the audio that is playing, go back a certain amount of time, etc.)

The pressing of a button of the activation unit once or a succession of times may output keyboard commands that are received and processed by the smartphone that carries out the following steps. The following exemplary set of steps may be for when a smartphone is an iPhone® and the application program that is playing the audio is the iBooks® application program (however, it will be appreciated that these steps may be adapted for a different smartphone, the desired media playback application program, and/or the actions to be carried out on the application program as a result of the pressing of the button of the activation unit):
Open the search bar on the smartphone;
Type in the app name (for example iBooks®);
Navigate to choose iBooks® in the search results (e.g. iBooks® is the first to be listed in the search results). The iBooks® app will come up in the foreground;
Navigate to the first of icon of the playback control icons;
Use the activator button to navigate to the playback icon the user wants to select. For example, if the user seeks to rewind the story 45 seconds because he or she missed something, the user may press a button of the activation unit 3 times, where the button of the activation unit corresponds to the rewind button of the application program (each press is 15 seconds rewind).

In the examples where the activation unit may have multiple buttons, each of the buttons may be configured to perform a different action on the media playback application program. In some examples, the buttons of the activation unit may be configured to mimic the layout of the control icons of the media playback application program as they appear in the application program.

### Example 4: Activation Unit for Enhanced Reality Gaming

In some examples, the activation unit may be configured for an enhanced reality gaming application program on a smartphone, such as one that utilizes the user's GPS coordinates to trigger certain events in the game. The game application program may be in background mode. The user may not want to continuously look at his or her screen as the user is moving between locations. The activation unit may comprise in some examples a signalling feature, such as a vibration device as is known in the art of a light signal. The activation unit may be in communication with the smartphone via a wireless connection (via, for instance, a Bluetooth connection), and when an event occurs in the game, the smartphone may communicate and send the activation unit a signal via the wireless connection indicating that an event has taken place in the game. The activation unit processes the signal and draws the user's attention via the signaling feature. The user may then press the button on the activation unit to send out a sequence of keyboard commands to the smartphone to, e.g., unlock the smartphone, open the search bar on the app phone, type the game app name, select the first option (e.g. bringing the game application program from background to foreground mode), and carry out the desired function in the game application program associated with the button of the activation unit, such as collecting an item in the game that is associated with the user's GPS coordinates as presented by the application program.

Activation Unit and Peripheral Device:

Reference is now made to FIG. 8 illustrating an exemplary activation unit 15 in communication with a peripheral device 52. Examples of a peripheral device 52 may be a mouse (wired or wireless), a camera, a keyboard (wired or wireless), a joystick, a trackpad, etc.

The computing device 12 may have an application program 21 that is specific to the peripheral device 52. For instance, the application program 21 may be one for viewing a stream of image data produced by a peripheral camera. It would be advantageous for the peripheral application program 21 to be activated once the peripheral device 52 is activated. Therefore, the activation unit 15 may detect when the peripheral device 52 is turned on, and send a sequence of keyboard commands in response to the computing device 12 to cause the running of the peripheral application program 21.

The peripheral device 52 may communicate with a peripheral data interface 41 of the activation unit 15. The peripheral device 52 may establish a wired or wireless connection with the peripheral data interface 41. An exemplary wireless connection is a Bluetooth connection. The peripheral data interface 41 may be a data transceiver (or a combination of a transmitter and receiver) for transmitting and receiving data to and from the peripheral device 52.

The peripheral data interface 41 may detect when the peripheral device 52 is activated. The peripheral data interface 41 may then transmit a signal that is received and processed by the consumer control key transmission module 26 to retrieve from memory 24 a sequence of keyboard commands that is to cause the activation of the peripheral application program 21. The sequence of keyboard commands is then sent via the data connection established between data interface 16c (e.g. Bluetooth interface) and the data interface 16a (e.g. data interface). The sequence of keyboard commands is then processed by the OS (e.g. modules 18 and 20) of the computing device 12, causing the launching or switching of the peripheral application program 21 to the foreground.

In some examples, the activation unit 15 may be integrated into the peripheral device 52. In other examples, the activation unit 15 may be separate from the peripheral device 52.

Exemplary Activation Unit 15:

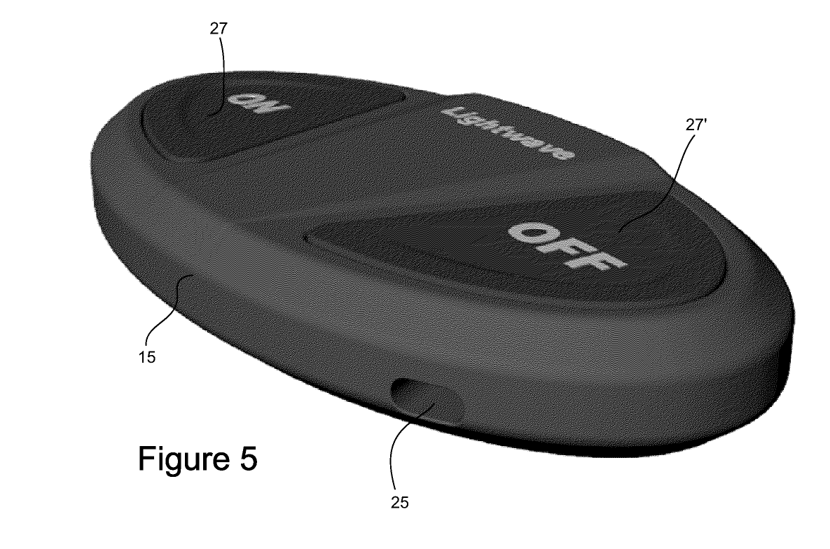

FIG. 5 shows a view of a stick-on activation unit 15 that includes a single ON button 27 and a single OFF button 27′. Unit 15 can be powered using a standard button battery (e.g. a Lithium CR2032 type battery) or alternatively, when used in a vehicle to control a smartphone, it can be powered from the vehicle (or any other external power) using wire port 25. Unit 15 includes the Bluetooth transceiver chip. When the button 27 of unit 15 is pressed, a signal is sent to the smartphone 12 that causes its Bluetooth component 16a to cause the smartphone 12 to wake up, unlock, and/or carry out the designated action associated with the pressing of the button, as configured. In some embodiments, the unit 15 can conserve its battery life for years, by remaining in sleep mode and only periodically wake up to establish Bluetooth communication.

In some examples, the activation unit 15 may be software-based, such as an application program.

The description of the present invention has been presented for purposes of illustration but is not intended to be exhaustive or limited to the disclosed embodiments. Many modifications and variations will be apparent to those of ordinary skill in the art.

1. An activation device for controlling a computing device having an external keyboard interface for connecting and receiving keyboard input from an external keyboard and an operating system, comprising:
a user input interface;
a keyboard interface for connecting to said external keyboard interface of said computing device;
a memory for storing at least one sequence of keyboard commands that is configured to be received by a operating system of said computing device and processed by said operating system of said computing device to cause said operating system to carry out designated functions on said computing device, said at least one sequence of keyboard commands comprising at least one of:
a first sequence of keyboard commands for causing the unlocking of said computing device; and
a second sequence of keyboard commands for causing the user interface of said operating system to navigate through application programs, to select a designated application program amongst said application programs and to launch said designated application program; and
a controller configured to be responsive to said user input interface for transmitting at least one of said at least one sequence of keyboard commands stored in said memory to said external keyboard interface of said computing device.

2. The activation device as defined in claim 1, wherein said keyboard interface is a wireless interface, preferably Bluetooth.

3. The activation device as defined in claim 1, wherein said keyboard interface is a wired interface.

4. The activation device as defined in claim 1, wherein said at least one sequence of keyboard commands comprises a sequence of keyboard commands for causing said operating system to switch a first application program running in the foreground to the background, and to bring a second application program to said foreground.

5. The activation device as defined in claim 1, wherein said user input interface comprises a plurality of user keys, each associated with a predetermined sequence of keyboard commands.

6. The activation device as defined in claim 5, wherein one of said plurality of user keys is associated with a predetermined sequence of keyboard commands to cause said computing device to select a predetermined touch-screen keyboard.

7. The activation device as defined in claim 1, wherein said activation device is adapted to receive and respond to data from the computing device.

8. The activation device as defined in claim 7, wherein said keyboard interface is further configured to receive keyboard command data from said computing device, and wherein said memory is further configured to store said received keyboard command data.

9-13. (canceled)

14. The activation device as defined in claim 1, further comprising a battery for powering said activation device.

15. An activation device for controlling a computing device having an external keyboard interface for connecting and receiving keyboard input from an external keyboard by an operating system of the computing device, comprising:
a data transceiver having a configuration defining transmission of messages over an established connection and responses to received messages, said received messages;
computer readable memory configured to store at least one sequence of keyboard commands to cause an operating system of said computing device to process said sequence of keyboard commands and a user interface of said operating system of said computing device carry out a specific function;
a controller configured to be responsive to a trigger response message received by said data transceiver to transmit said first sequence of keyboard commands stored in said memory to said external keyboard interface of said computing device,
wherein said data transceiver is configured to:
establish a data connection with said computing device, and
once said data connection is established between said data transceiver and said computing device, periodically send over said data connection messages to said smartphone to cause an activation of a user input detection application program to run on said computing device and to detect user input, in response to which said user input detection application program is configured to send said trigger response message.

16. The activation device as defined in claim 15, wherein said data transceiver is a wireless transceiver, and wherein said data connection is a wireless connection.

17. The activation device as defined in claim 16, wherein said wireless transceiver is a Bluetooth wireless transceiver, and said wireless connection is a Bluetooth connection.

18. The activation device as defined in claim 15, wherein said data connection is a wired connection.

19. The activation device as defined in claim 15, wherein said data connection messages are pings.

20. The activation device as defined in claim 15, wherein said first sequence of keyboard commands is to cause said computing device to unlock.

21. The activation device as defined in claim 15, further comprising a user input interface configured to receive additional user input, wherein said at least one sequence of keyboard commands comprises an additional input sequence of keyboard commands associated with said additional user input, and wherein said controller is further configured to be responsive to said additional user input to transmit at least one of said at least one sequence of keyboard commands.

22. (canceled)

23. The activation device as defined in claim 21, wherein said user input interface is at least one button.

24. The activation device as defined in claim 21, wherein said user input interface is a motion sensor.

25. (canceled)

26. The activation device as defined in claim 21, wherein said user input interface comprises a plurality of user keys, each associated with a predetermined sequence of keyboard commands.

27-39. (canceled)

40. An activation device for controlling a computing device having an external keyboard interface for connecting and receiving keyboard input from an external keyboard and an operating system, comprising:
a user input interface;
a keyboard interface for connecting to said external keyboard interface of said computing device;
a memory for storing at least one sequence of keyboard commands that is configured to be received by a operating system of said computing device and processed by said operating system of said computing device to cause said operating system to carry out designated functions on said computing device, said at least one sequence of keyboard commands comprising:
a first sequence of keyboard commands for causing the unlocking of said computing device; and
a controller configured to be responsive to said user input interface for transmitting at least one of said at least one sequence of keyboard commands stored in said memory to said external keyboard interface of said computing device.
